(19) United States
(12) Patent Application Publication
(10) Pub. No.: US 2005/0079985 A1
(43) Pub. Date: Apr. 14, 2005

(54) Method of preventing odors

(76) Inventor: Yocheved Shasho, Tel Aviv (IL)

Correspondence Address: Bernard Malina, Suite 501, 60 East 42nd Street, New York, NY, 10165, US

(21) Appl. No.: 10/965,426

(22) Filed: Oct. 13, 2004

Related U.S. Application Data
(60) Provisional application No. 60/511,624, filed on Oct. 14, 2003.

(51) Int. Cl. C11D 1/00

(52) U.S. Cl. 510/191

(57) ABSTRACT

A method of preventing odors in a toilet bowl includes the introduction of a compound into the toilet bowl whereby the pH of the overall composition is about 11.5.

### RELATED APPLICATIONS

This application claims priority of Provisional Application Ser. No. 60,511,624, filed Oct. 14, 2003.

### FIELD OF THE INVENTION

The present invention relates to a method of preventing odors and, more particularly, to a method for preventing the creation of odors associated with the use of flush toilets.

### BACKGROUND OF THE INVENTION

The prior art includes the following U.S. patents. U.S. Pat. No. 6,291,411 to Callaghan et al. discloses a process for cleaning toilet bowls and a composition having bleaching and lime scale removal properties. The method disclosed by Callaghan comprises pouring into the interior of the toilet bowl from a container an aqueous liquid composition comprising a hypochloride bleach and a bleach resistant organic sequestering agent having a molecular weight below 1,500 which sequesters calcium and subsequently flushing the toilet.

U.S. Pat. No. 4,755,354 to Trink et al. discloses a method of automatic brushless removal of existing soil and long term maintenance cleaning of flush toilet bowls with bromide activated hypochlorite salts. The method disclosed by Trink et al. is particularly directed to automatic bowl cleaning by separately but simultaneously dispensing a bromide salt and a hypochlorite sanitizing agent into the toilet bowl with each flush.

U.S. Pat. No. 4,731,223 to Forestier et al. discloses a method for cleaning toilet bowls whereby a composition may be applied to the reservoir or tank of the toilet bowl. Thus, the composition which includes at least one amine oxide, at least one appropriate colorant, and at least one pH regulating agent is, together with the reservoir water, discharged into the bowl after each use. In Forestier et al., the composition is such that the pH of the aqueous mixture in the toilet bowl is about 6.3±0.5.

U.S. Pat. No. 4,896,382 to Sokol et al. discloses a toilet bowl cleaning device which dispenses a metered amount of cleaning solution into a toilet bowl after each flush.

The above-mentioned prior art references, however, do not deal with the problem of preventing the formation of offensive odors during and after toilet use.

### OBJECTS AND SUMMARY OF THE INVENTION

It is accordingly an object of the present invention to provide a method which prevents the formation of offensive odors during and after use of the toilet bowl.

In accordance with the principle of the present invention, a composition is introduced to the water in the bowl prior to use. The composition found to be most effective is a liquid comprising a composition of approximately 6% sodium hypochloride (NaOCL), approximately 5.6% sodium chloride, and approximately 0.15% caustic, i.e., hydroxide of a light metal, by weight. In its liquefied form, the balance of the composition comprises water and inert ingredients whereby the pH of the overall composition is about 11.5.

The amount of the composition of the present invention to be poured into the toilet bowl may vary in accordance with the concentration of the composition, i.e., the ratio of water and inert ingredients to the remaining ingredients mentioned above. It has been found that introduction of an ounce of the above liquid composition into a conventional sized toilet bowl before toilet use is effective in preventing the formation of normally occurring odors after toilet use.

The most effective results in the use of the composition of the present invention are obtained when the aforementioned composition is poured into the toilet bowl water prior to toilet use. It has been found that some, but lesser deodorizing effect is obtained in introducing the inventive composition into the toilet bowl after use, but before flushing.

### DETAILED DESCRIPTION OF THE INVENTION

According to one aspect of the invention there is provided a method of preventing odors in a flush toilet which comprises: (a) pouring into the toilet bowl a composition which comprises sodium hypochloride, sodium chloride, caustic and water with the composition having a pH of about 11.5, and (b) flushing the toilet. The caustic is preferably hydroxide of a light metal.

The most effective composition has been found to have the following approximate composition by weight:
6% sodium hypochloride;
5.6% sodium chloride; and
0.15% caustic.

The balance of the composition is water and inert ingredients. The pH of the overall composition is about 11.5.

The amount of the composition poured into the toilet bowl is approximately one ounce.

The amount of the composition of the present invention to be poured into the toilet bowl may vary in accordance with the concentration of the composition, i.e., the ratio of water and inert ingredients to the remaining ingredients mentioned above.

The most effective results in the use of the composition of the present invention are obtained when the aforementioned composition is poured into the toilet bowl water prior to toilet use. It has been found that some, but lesser deodorizing effect is obtained in introducing the invention composition into the toilet bowl after use, but before flushing.

Although the present invention has been described in connection with the preferred embodiment thereof, many other variations and modifications will become apparent to those skilled in the art without departing from the scope of the invention.

1. A method of preventing odors in toilet bowls which comprises the steps of:
a) preparing a composition which comprises sodium hypochloride, sodium chloride, caustic and water whereby the pH of the composition is about 11.5; and
b) introducing said composition into water in the toilet bowl.

2. The method as claimed in claim 1 wherein said caustic comprises hydroxide of a light metal.

3. The method as claimed in claim 1 wherein said composition comprises by weight approximately 6% sodium hypochloride, approximately 5.6% sodium chloride and approximately 0.15% caustic.

4. The method as claimed in claim 1 wherein said step of introducing said composition into the toilet bowl is performed prior to use.

5. The method as claimed in claim 1 wherein said step of introducing said composition into the toilet bowl is performed after use and prior to flushing.
